(19) United States
(12) Patent Application Publication
(10) Pub. No.: US 2015/0378424 A1
(43) Pub. Date: Dec. 31, 2015

(54) Memory Management Based on Bandwidth Utilization

(71) Applicant: Telefonaktiebolaget L M Ericsson (publ), Stockholm (SE)

(72) Inventor: Andreas Anyuru, Lund (SE)

(21) Appl. No.: 14/316,985

(22) Filed: Jun. 27, 2014

(51) Int. Cl. G06F 1/32

(52) U.S. Cl. CPC G06F 1/3234

(57) ABSTRACT

A processing system includes a memory circuit configured for operation at a plurality of frequency-voltage operating points and one or more processing elements operatively coupled to the memory circuit. A memory-bandwidth measurement circuit repeatedly measures run-time bandwidth utilization of the memory circuit, while a controller circuit dynamically adjusts the voltage-frequency operating point of the memory circuit as a function of the measured run-time bandwidth utilization. The controller circuit uses a feedback process that includes determining whether previous adjustments to the voltage-frequency operating point have tended to provide too little memory bandwidth or too much memory bandwidth, based on measurements of run-time bandwidth utilization performed after each of a plurality of previous adjustments to the voltage-frequency operating point of the memory, and dynamically changing one or more bandwidth utilization thresholds used to trigger adjustments to the voltage-frequency operating point, based on the determining.

### TECHNICAL FIELD

The presently disclosed techniques relate to memory management techniques in processing systems.

### BACKGROUND

Power consumption of the processing system is an important characteristic for mobile devices. Increased capabilities in mobile devices have led to their reliance on more complex processing systems, which may include one or several general-purposes microprocessors, digital signal processors, graphics processors, etc. Because these more complex processing systems in turn put increasing demands on the batteries of the devices, several different strategies to save power have evolved.

One example of these strategies is called “CPU frequency scaling.” This approach is implemented in the Linux kernel, using the cpufreq framework. The cpufreq framework implements a technique called Dynamic Voltage Frequency Scaling (DVFS), where the voltage and the frequency for the central processing unit (CPU) are changed dynamically, in run-time, allowing the system to decrease voltage and frequency to save power when less performance is needed by the system.

The combination of a voltage and frequency pair for a device or subsystem is often referred to as an operating point, or “OPP.” A “25% OPP” might refer, for example, to a frequency and voltage pair where the frequency is at 25% of the maximum frequency for the device, given the voltage, while a “50% OPP” might refer to a frequency and voltage pair where the frequency is at 50% of the maximum frequency for the device, given the voltage.

In The DVFS used for a CPU can be used in a similar manner for other hardware components in a system-on-a-chip (SoC) in a mobile device. A SoC is often divided into several voltage domains, where each voltage domain is supplied from its own switched-mode power supply (SMPS). DVFS can be applied separately in each voltage domain, so that a voltage domain that requires less performance at a certain time can have a lower OPP than another domain that needs higher performance at the same time.

Random-access memory (RAM) is now typically a key part of the processing systems in mobile devices. The RAM in mobile devices today usually includes some sort of low power synchronous dynamic RAM (SDRAM), such as LPDDR2, which is a low-power double data-rate synchronous DRAM specified by the JEDEC Solid State Technology Association (JEDEC). When the term “DDR” in the rest of this document, any type of double data-rate SDRAM memory is meant. The exact version (e.g. LPDDR, LPDDR2 or LPDDR3) of DDR is not important.

To save power when using DDR memory, the memory can be put in different kind of low power states (such as a “partial array self-refresh” state or a “deep power-down” state), where some logic of the memory is disabled to save power when the memory is not used actively. In addition to these low power states where part of the logic is disabled or clocks are gated, DVFS can also be used when the DDR memory is in the active state. The DVFS of the memory may have a default OPP that is, for example, 25% of max OPP. Then, when higher memory bandwidth is needed, the OPP can be increased to, for example, a 50% OPP, a 75% OPP, or a 100% OPP.

There are two common ways to take the decision to increase the OPP for a DDR memory:
In some cases, a device driver for an IP block may know in advance that it will need high memory bandwidth for a certain use case. For example, in a specific SoC implementation it might be the case that decoding high resolution video requires that the DDR memory OPP to be increased, to get sufficient performance. In these cases, the device driver or a user-space application can request that the DDR memory OPP be increased, e.g., to a 100% OPP, before the decoding is started.
Another approach is to connect the DDR memory OPP to the load of the CPU. This means that when the DVFS framework (e.g., the Linux cpufreq framework) increases the frequency of the CPU, it is assumed that the system also needs a higher memory bandwidth, and therefore the DDR memory OPP is also increased. Then, when the CPU load goes down, the memory OPP is decreased again.

These existing solutions thus either set the DDR OPP based on the load on the CPU or by letting an application or device, such as a HW video decoder, explicitly ask for a certain DDR OPP when needed. The problem with these approaches is that there are cases when they do not work well.

For example, it is not always the case that a high CPU load means high memory bandwidth utilization. There are also cases when the CPU load is low but the memory bandwidth requirement is high. When measuring the CPU load and adjusting the DDR memory OPP after the CPU load there will be a problem if, for example, it is a processing element other than the CPU that is using a large portion of the memory bandwidth, such a Long-Term Evolution (LTE) or Wideband Code-Division Multiple Access (WCDMA) hardware accelerator, a graphics processing unit (GPU), a direct memory access (DMA) device. In such a situation, the CPU load might be very low even while, for example, the GPU is reading a lot of data from the DDR memory.

The approach of letting different devices ask for a specific OPP when they “know” they need high memory bandwidth also has problems. First, this strategy only works for use cases where a system designer knows in advance that there will be high bandwidth requirement. On many computer systems (e.g., a smartphone, a tablet, a modem in a mobile hotspot configuration, etc.), the software on the device can be updated in the end product, creating combinations of applications and use cases that may not be anticipated by the system designer. Thus, the load on the DDR memory might also change after production of the device, and static schemes to control DDR OPP will work less well. For example, if a user-space application that performs a lot of DDR memory accesses is downloaded to a device, there is a risk that the DDR will be clocked at too low a frequency, which means that the memory may not provide the desired memory bandwidth.

### SUMMARY

According to some embodiments of the techniques and systems disclosed herein, the problems described above are addressed with a processing system that includes a memory circuit configured for operation at a plurality of frequency-voltage operating points and one or more processing elements operatively coupled to the memory circuit. A memory-bandwidth measurement circuit repeatedly measures run-time bandwidth utilization of the memory circuit, while a controller circuit dynamically adjusts the voltage-frequency operating point of the memory circuit as a function of the measured run-time bandwidth utilization. The adjustment may be based on one or more other parameters as well, in some embodiments, such as on a charging level of a battery associated with the processing system.

The controller circuit uses a feedback process that includes determining whether adjustments to the voltage-frequency operating point have tended to provide too little memory bandwidth or too much memory bandwidth, based on measurements of run-time bandwidth utilization performed after each of a plurality of the adjustments to the voltage-frequency operating point of the memory circuit, and dynamically changing one or more bandwidth utilization thresholds used to trigger adjustments to the voltage-frequency operating point, based on the determining. In some embodiments, the feedback process includes determining whether the adjustments to the voltage-frequency operating point have tended to provide too little memory bandwidth or to provide too much memory bandwidth by: incrementing a first counter value for each instance in which the measured run-time bandwidth utilization after an adjustment to the voltage-frequency operating point indicates that an available memory bandwidth is insufficient; incrementing a second counter value for each instance in which the measured run-time bandwidth utilization after an adjustment to the voltage-frequency operating point indicates that an available memory bandwidth is more than is required; and comparing the first and second counter values, wherein the first counter value exceeding the second counter value by at least a first predetermined threshold indicates that the adjustments to the voltage-frequency operating point have tended to provide too little memory bandwidth and wherein the second counter value exceeding the first counter value by at least a second predetermined threshold indicates that the adjustments to the voltage-frequency operating point have tended to provide too much memory bandwidth.

In some embodiments, the controller circuit is one of the one or more processing elements, and is configured to retrieve memory utilization information from the memory-bandwidth measurement circuit and to adjust the voltage-frequency operating point of the memory circuit via a memory controller circuit. In other embodiments, the processing system comprises a bus analyzer circuit that includes the controller circuit and the memory-bandwidth measurement circuit, and where the bus analyzer circuit is configured to adjust the voltage-frequency operating point of the memory circuit via a memory controller circuit.

In some embodiments, the controller circuit is configured to adjust the voltage-frequency operating point of the memory circuit in dependence on which of the one or more processing elements has or have increasing or decreasing memory bandwidth requirements. In some of these and in some other embodiments, the controller circuit is configured to adjust the voltage-frequency operating point based further on performance metrics from one or more of the processing elements, which performance metrics may comprise, for example, cache-miss ratios from one or more of the processing elements. In some embodiments, the controller circuit is further configured to determine that a cache-miss ratio exceeds a predetermined threshold value, trigger a retrieval of a measured run-time bandwidth utilization of the memory circuit, based on this determination, and perform the adjusting of the voltage-frequency operating point as a function of the retrieved measured run-time bandwidth utilization.

Example methods for managing power consumption of memory in processing systems corresponding to those systems summarized above are also detailed herein. Those skilled in the art will appreciate further features and advantages of these systems and methods upon reviewing the accompanying drawings and the detailed description that follows.

### BRIEF DESCRIPTION OF THE DRAWINGS

The accompanying drawings, which are included to provide a further understanding of the disclosure and are incorporated in and constitute a part of this disclosure, illustrate certain non-limiting embodiment(s) of the methods and apparatus described herein. In the drawings:

FIG. 1 is a block diagram illustrating components of an example processing system configured according to some of the presently disclosed techniques;

FIG. 2 illustrates an example of how operating points (OPPs) of a memory can be varied as a function of measured bandwidth utilization;

FIG. 3 illustrates another example of how OPPs of a memory can be varied as a function of measured bandwidth utilization; and

FIGS. 4, 5, and 6 are process flow diagrams illustrating example methods according to the presently disclosed techniques.

### DETAILED DESCRIPTION

In the following detailed description, numerous specific details are set forth in order to provide a thorough understanding of the techniques and apparatus disclosed herein. However, it will be understood by those skilled in the art that the present techniques may be practiced without these specific details. In other instances, well-known methods, procedures, components and circuits have not been described in detail so as not to obscure the present disclosure.

As discussed above, existing solutions for setting the operating point (OPP) of a memory either set the OPP based on the load on the central processing unit (CPU) or by letting an application or device, such as a hardware video decoder, explicitly ask for a certain OPP when needed. The problem with these approaches is that there are cases when they do not work well. For example, it is not always the case that a high CPU load means high memory bandwidth utilization. There might be cases, for instance, where the CPU load is very low even while a graphics processing unit (GPU) is reading a lot of data from the memory. The approach of letting different devices ask for a specific OPP when they “know” they need high memory bandwidth also has problems, since this strategy only works for use cases where a system designer knows in advance that there will be high bandwidth requirement.

These problems addressed with a processing system that includes a memory circuit configured for operation at a plurality of frequency-voltage operating points and one or more processing elements operatively coupled to the memory circuit. A memory-bandwidth measurement circuit repeatedly measures run-time bandwidth utilization of the memory circuit, while a controller circuit dynamically adjusts the voltage-frequency operating point of the memory circuit as a function of the measured run-time bandwidth utilization. The adjustment may be based on one or more other parameters as well, in some embodiments, such as on a charging level of a battery associated with the processing system.

Thus, for example, a bandwidth load measurement hardware block is connected to the main memory interconnect and used to measure run-time bandwidth utilization on the DDR memory in a system-on-a-chip (SoC) designed for mobile devices. The hardware block may be a hardware block that is normally used for tracing and debugging purposes, re-purposed to perform the run-time bandwidth utilization measurements, such as the STBus Analyzer Generic (SBAG) system-bus analyzer provided by STMicroelectronics to support its STBus for SoC applications.

When the bandwidth utilization increases over a certain level it is possible to increase the OPP, permitting the DDR to be able to deliver the required performance. Likewise, when the bandwidth utilization decreases under a certain level the DDR OPP can be lowered to save power. The bandwidth load measurements may be combined with measurements from performance counters from the CPU and/or from any other IP blocks that have performance counters. As detailed below, performance counters for cache miss ratios may be especially useful information in taking a decision about the next DDR OPP.

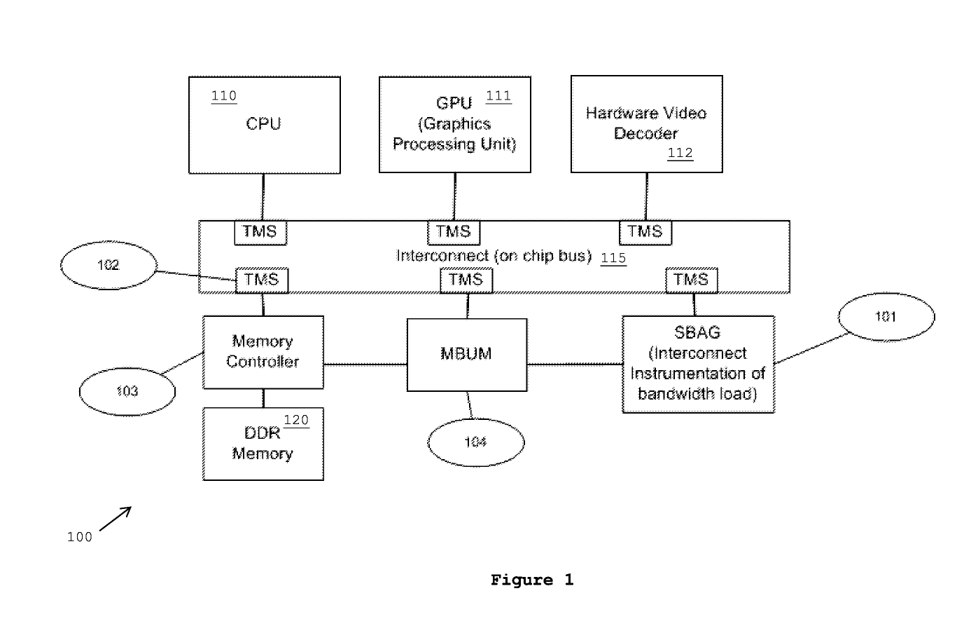

FIG. 1 is a block diagram illustrating components of an example processing system 100 configured according to some of the presently disclosed techniques. As seen in the figure, several distinct processing elements, including CPU 110, graphics processing unit (GPU) 111, and a hardware video decoder 112, access a DDR memory 120, via an on-chip bus interconnect 115 and a memory controller 103. Other processing elements that might be included in similar circuits include, for example, modem hardware accelerators, direct memory access (DMA) controllers, etc.

In the illustrated example, a run-time bus analyzer, here an SBAG 101, monitors the bandwidth utilization on the DDR memory controller 103 with the help of one of several traffic measurement satellite (TMS) circuits 102, which are connected to and provide measurement data to the SBAG 101. When the bandwidth utilization increases above a first preconfigured value BW_UTILIZATION_HIGH_1, the SBAG 101 “signals” this change to a memory bandwidth utilization module (MBUM) 104. Note that the preconfigured threshold value BW_UTILIZATION_HIGH_1 can be adjustable; details of a feedback loop used to adjust the value are provided below. The MBUM can be a separate IP block in the system-on-chip (SoC) design, but could also be implemented as part of another circuit block, such as in a power rest clock management unit (PRCMU) or other circuit block that interfaces with the DDR memory to set up the operating points for the DDR memory 120.

The signaling from the SBAG 101 to the MBUM 104 can be carried out in different ways for different embodiments. As an example, in one embodiment an interrupt can be raised by the SBAG 101 when the bandwidth utilization goes above the preconfigured value BW_UTILIZATION_HIGH_1, and the MBUM 104 can then increase the OPP of the DDR memory 120 in response. If the bandwidth utilization falls below another preconfigured value BW_UTILIZATION_LOW_1, another interrupt is triggered by SBAG 101 and the MBUM 104 can decrease the OPP of the DDR memory 120 again. In an alternative embodiment, the signaling between the SBAG 101 and the MBUM 104 can happen through a single interrupt line and a shared memory that the SBAG 101 writes to and MBUM 104 reads from.

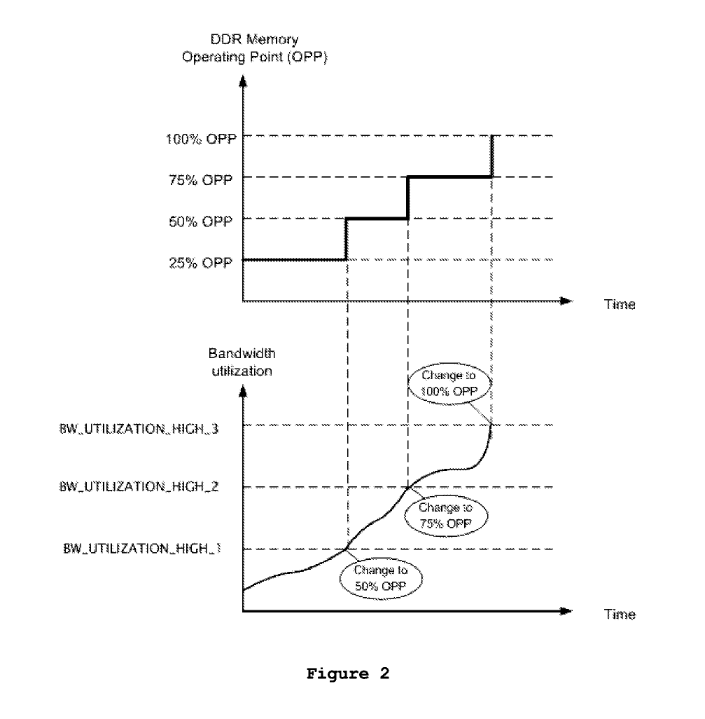

FIG. 2 illustrates an example of how the OPPs of the DDR memory 120 could vary with the measured bandwidth utilization, according to some embodiments of the presently disclosed technique. The lower part of the diagram shows how the measured bandwidth utilization increases and crosses the preconfigured limits BW_UTILIZATION_HIGH_1, BW_UTILIZATION_HIGH_2 and BW_UTILIZATION_HIGH_3, while the upper part of the diagram shows the changing operating points for the DDR memory 120, which are set in response to the changes in bandwidth utilization.

Here, FIG. 2 is described in terms of the operation of the example circuit shown in FIG. 1. However, it will be appreciated that similar circuits could be used to achieve similar operation, including circuits with different names for the various circuit blocks and/or with different partitioning of the illustrated functionality.

As seen at the left-hand side of the top portion of FIG. 2, the DDR memory 120 is set to a default DDR OPP of 25% OPP as soon as the DDR memory 120 is active. As seen in the lower portion of the figure, the bandwidth utilization of the circuit gradually increases with time in the illustrated example. When the bus analyzer 101 measures a bandwidth utilization that is above BW_UTILIZATION_HIGH_1, it signals this to the MBUM 104, which increases the DDR OPP to 50% OPP by writing to the DDR controller 103. This step change to the 50% OPP can be seen in the top portion of the figure. Similarly, when the bus analyzer 101 measures a bandwidth utilization that is above BW_UTILIZATION_HIGH_2, this will be signaled to MBUM 104, which again increases the DDR OPP to 75% OPP. Finally, if the bus analyzer 101 measures a bandwidth utilization that is above BW_UTILIZATION_HIGH_3, this will be signaled to MBUM 104, and the DDR OPP will be set to 100% OPP.

Of course, the operation shown in FIG. 2 is only an example. Some implementations may employ more or fewer operating points, with corresponding thresholds for switching between the operating points. Different thresholds may be used for decreasing the DDR memory's performance, in some embodiments, to provide a hysteresis effect, so that overly rapid switching between OPPs is avoided. Other variations in behavior are possible as well.

The logic for how the OPPs of the DDR memory 120 are changed in response to the measured bandwidth utilization can be implemented as different governors to the MBUM 104. The choice of governor that is most appropriate for a particular SoC application could be configured statically, at build time. Alternatively, the SoC may be configured to dynamically select from among a set of several different pre-configured governor configurations, in run-time to get different performance and power characteristics for the device at different points in time. For example, in one embodiment the MBUM governor could be changed in run-time in dependence on the charging level of the battery. If the battery is almost discharged, a “power-save governor” could be used, where the power-save governor is designed to save power at the expense of lower available memory bandwidth, and thus lower overall performance. When the battery is fully charged, a “performance governor” could be used, the performance governor having the property that it focuses on delivering as high a performance as possible, by increasing the DDR OPP more quickly when an increase in the bandwidth utilization is noticed.

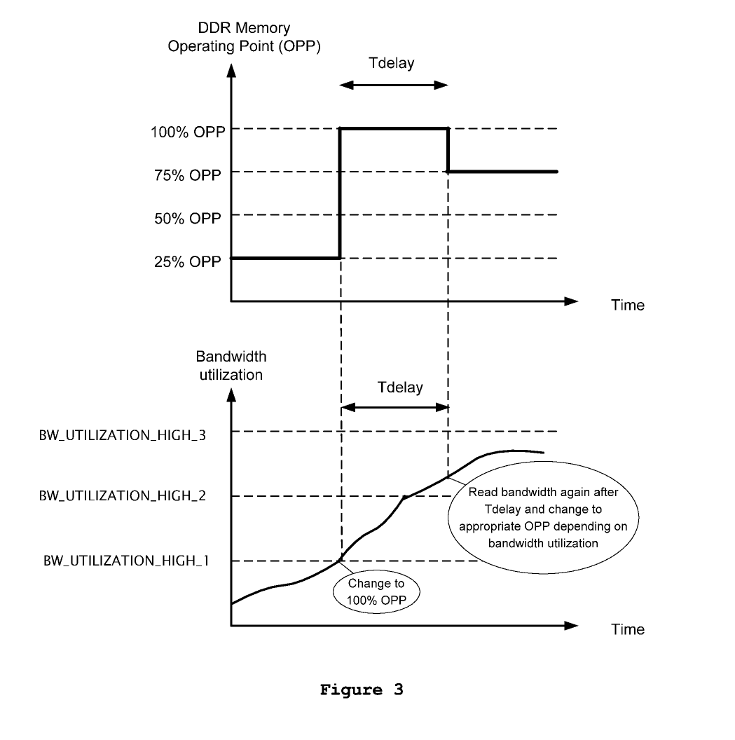

FIG. 3 illustrates how a “performance governor” could behave when an increase in bandwidth utilization is detected. Here, when the measured bandwidth increases above BW_UTILIZATION_HIGH_1, the DDR OPP is directly increased to the 100% OPP. This allows the achievement of high performance very quickly, in response to a detected increase in memory bandwidth utilization. After a particular time delay, shown as Tdelay in FIG. 3, the bandwidth utilization is read again, and the DDR OPP can be adjusted, if necessary, to a level that better matches the bandwidth utilization measured at this point.

A feedback loop can be incorporated into the operation of the circuits discussed above. The feedback loop can help ensure that the system changes the DDR operating point at the best possible time, i.e., not too late, so that not enough bandwidth is available when needed by the system, and not too early, so that unnecessary power is consumed when not needed. The feedback loop can achieve this by dynamically adjusting the levels that are used to evaluate the bandwidth utilization and to trigger changes in the operating points.

For example, referring once again to the circuit implementation shown in FIG. 1, after the bus analyzer 101 signals to MBUM 104 that a bandwidth increase has happened, the bus analyzer 101 will wait a short time (DELAY_INC_MEASURE) and then measure the memory bandwidth that is actually used from all the processing elements (e.g., CPU 110, modem hardware accelerators, GPU 111, DMA, etc.) towards the DDR memory 120. If the measured bandwidth, here called BW_MEASURED, is higher than the available bandwidth for that specific OPP (ACTUAL_BW_AVAILABLE) MBUM will increase a counter, COUNT_AVAILABLE_BW_TOO_LOW. This counter indicates the number of times the OPP for the DDR was not increased early enough for a given OPP level. This means that there is one counter COUNT_AVAILABLE_BW_TOO_LOW for each of the levels BW_UTILIZATION_HIGH_1, BW_UTILIZATION_HIGH_2 and BW_UTILIZATION_HIGH_3, so each level can be measured and adjusted independently of each other.

If the measured bandwidth instead has too large a margin until it reaches the available bandwidth (ACTUAL_BW_AVAILABLE), indicating that there is excessive memory bandwidth available, another counter (COUNT_AVAILABLE_BW_TOO_HIGH) is increased. This counter indicates how many times the OPP for the DDR was increased too early for this specific OPP level. Again, there is a separate counter for each of the levels BW_UTILIZATION_HIGH_1, BW_UTILIZATION_HIGH_2 and BW_UTILIZATION_HIGH_3.

At regular intervals, which would normally be much longer than other delays mentioned here, MBUM 104 checks the counters COUNT_AVAILABLE_BW_TOO_LOW and COUNT_AVAILABLE_BW_TOO_HIGH. These intervals may be defined by a parameter DELAY_INC_MEASURE, for example. Logic like the following may be used to adjust the levels used by the bus analyzer 101 to determine when to signal to MBUM 104 that a change in bandwidth is needed:

```
if ((COUNT_AVAILABLE_BW_TOO_HIGH - COUNT_AVAILABLE_BW_TOO_LOW) >
COUNTER_TOO_HIGH_LEVEL) {
  // This means that on an average the available bandwidth has been too high
  // i.e. we increased the DDR OPP too early and wasted power.
  // MBUM will instruct SBAG to increase the level for
  // which SBAG interrupts MBUM due to an increase in bandwidth load.
  // Note that “increase the level” will mean that SBAG will not signal to MBUM
  // until the measured bandwidth has reached a higher value.
  IncreaseBandwidthLoadThreshold( )
}
else if ((COUNT_AVAILABLE_BW_TO_LOW - COUNT_AVAILABLE_BW_TO_HIGH) >
COUNTER_TO_LOW_LEVEL) {
  // This means that on an average the available bandwidth has been too low
  // i.e. we increased the DDR OPP too late and did not meet the performance targets
  // decrease the bandwidth load levels for which SBAG should signal to MBUM
  // Note that “decrease the level” will mean that SBAG will signal to MBUM
  // already when the measured bandwidth has reached a lower value.
  DecreaseBandwidthLoadThreshold( )
}
```

As suggested above, circuit configurations having different partitioning of functionality from that illustrated in FIG. 1 are possible. For example, in some alternative embodiments of the circuit in FIG. 1, the bus analyzer 101 monitors the bandwidth utilization on the DDR memory controller 103 with the help of TMS 102, and then the CPU 110 reads the bandwidth utilization directly from a buffer in the bus analyzer 101. The CPU 110 can then communicate with the MBUM 104, which writes the new OPP to the DDR controller 103. The difference in this alternative embodiment is that the bus analyzer 101 does not communicate directly with the MBUM 104. Instead the CPU 110 reads from the bus analyzer 101 and writes to the MBUM 104, which writes to the DDR controller 103.

To further augment the system and take better decisions of when the DDR OPP should be changed, any of the circuits and/or techniques described above can be modified to take into account any of various other metrics, in addition to bandwidth utilization measurements, to dynamically adjust the operating points of the memory. These other metrics may include performance counters tracked in the CPU and/or in other IP blocks. For example, performance counters that count cache miss ratios can help to give an early indication of when a bandwidth increase towards the DDR memory will be needed.

When using performance counters to further enhance the OPP adjustments, the performance counters are used together with the bandwidth load measurements using, e.g., a bus analyzer like the SBAG 101 shown in FIG. 1. However, in this case there may typically be more levels than the BW_UTILIZATION_HIGH_1, BW_UTILIZATION_HIGH_2 and BW_UTILIZATION_HIGH_3 discussed above, such that the MBUM 104 is interrupted on a more fine-grained level instead of having one or two simple thresholds connected to each OPP.

For example, when using performance counters, the bus analyzer 101 may interrupt MBUM 104 in response to detecting a smaller increase or decrease in bandwidth load. When MBUM 104 is interrupted by the bus analyzer due to an increase of memory bandwidth load, the MBUM 104 evaluates the performance counter or performance counters to determine whether the DDR OPP should be increased. For instance, if cache miss performance counters are used, MBUM 104 will read the cache miss performance counters and increase the DDR OPP if the cache miss performance counters are above a certain value.

In other embodiments, this may be done the other way around, so that the initial trigger to consider whether the DDR OPP should be changed may come from the measurement of the performance counters (and not from a change in bandwidth load). Thus, when the cache miss ratio increases over a certain level, for example, the CPU 110 will read the current bandwidth load from the bus analyzer 101. If the current bandwidth load is over a certain level, the CPU 110 will signal to the MBUM 104 that it should change the DDR OPP.

In view of the detailed examples given above, it should be appreciated that embodiments of the techniques described herein include a processing system 100 that includes: a memory circuit configured for operation at a plurality of frequency-voltage operating points; one or more processing elements operatively coupled to the memory circuit and configured to store data in and retrieve data from the memory circuit; a memory-bandwidth measurement circuit operatively coupled to the memory circuit and configured to repeatedly measure run-time bandwidth utilization of the memory circuit, the run-time bandwidth utilization reflecting usage of the memory circuit by the one or more processing elements; and a controller circuit operatively coupled to the memory-bandwidth measurement circuit and to the memory circuit. The controller circuit is arranged to dynamically adjust the voltage-frequency operating point of the memory circuit as a function of the measured run-time bandwidth utilization. In some embodiments, the controller circuit uses a feedback process that includes determining whether previous adjustments to the voltage-frequency operating point have tended to provide too little memory bandwidth or to provide too much memory bandwidth, based on measurements of run-time bandwidth utilization performed after each of a plurality of previous adjustments to the voltage-frequency operating point of the memory, and dynamically changing one or more bandwidth utilization thresholds used to trigger adjustments to the voltage-frequency operating point, based on said determining.

In some embodiments, the controller circuit is configured to determine whether previous adjustments to the voltage-frequency operating point have tended to provide too little memory bandwidth or to provide too much memory bandwidth by: incrementing a first counter value for each instance in which the measured run-time bandwidth utilization after an adjustment to the voltage-frequency operating point indicates that an available memory bandwidth is insufficient; incrementing a second counter value for each instance in which the measured run-time bandwidth utilization after an adjustment to the voltage-frequency operating point indicates that an available memory bandwidth is more than is required; and comparing the first and second counter values, wherein the first counter value exceeding the second counter value by at least a first predetermined threshold indicates that the previous adjustments to the voltage-frequency operating point have tended to provide too little memory bandwidth and wherein the second counter value exceeding the first counter value by at least a second predetermined threshold indicates that the previous adjustments to the voltage-frequency operating point have tended to provide too much memory bandwidth.

While FIG. 1 illustrates one example of how the memory-bandwidth measurement circuit and controller circuit can be implemented, other partitioning of the functionality is possible. Thus, for example, in some embodiments one of the one or more processing elements (such as CPU 110) includes the controller circuit and is configured to retrieve memory utilization information from the memory-bandwidth measurement circuit and to adjust the voltage-frequency operating point of the memory circuit via a memory controller circuit (103). In other embodiments, such as those having a configuration similar to that of FIG. 1, the processing system comprises a bus analyzer circuit that includes the controller circuit and the memory-bandwidth measurement circuit, and that is configured to adjust the voltage-frequency operating point of the memory circuit via a memory controller circuit.

In some embodiments, the controller circuit is configured to adjust the voltage-frequency operating point of the memory circuit in dependence on which of the one or more processing elements has or have increasing or decreasing memory bandwidth requirements. Thus, for example, the same increase in memory bandwidth requirement may only sometimes result in a change in the operating point, depending on which particular processing element is responsible for the increase. Using this approach, bandwidth requirements for some processing elements may be prioritized over others.

In some embodiments, the controller circuit is configured to adjust the voltage-frequency operating point based further on a charging level of a battery associated with the processing system. In some of these and in some other embodiments, as discussed in detail above, the controller circuit is configured to adjust the voltage-frequency operating point based further on performance metrics from one or more of the processing elements. These performance metrics may include cache-miss ratios from one or more of the processing elements, for example. In some embodiments, an evaluation of a performance metric may trigger the bandwidth utilization measurement that ultimately triggers a change in memory operating point. For instance, the controller circuit in some embodiments may be configured to determine that a cache-miss ratio exceeds a predetermined threshold value, to trigger a retrieval of a measured run-time bandwidth utilization of the memory circuit, based on this determining, and to adjust the voltage-frequency operating point of the memory as a function of the retrieved measured run-time bandwidth utilization.

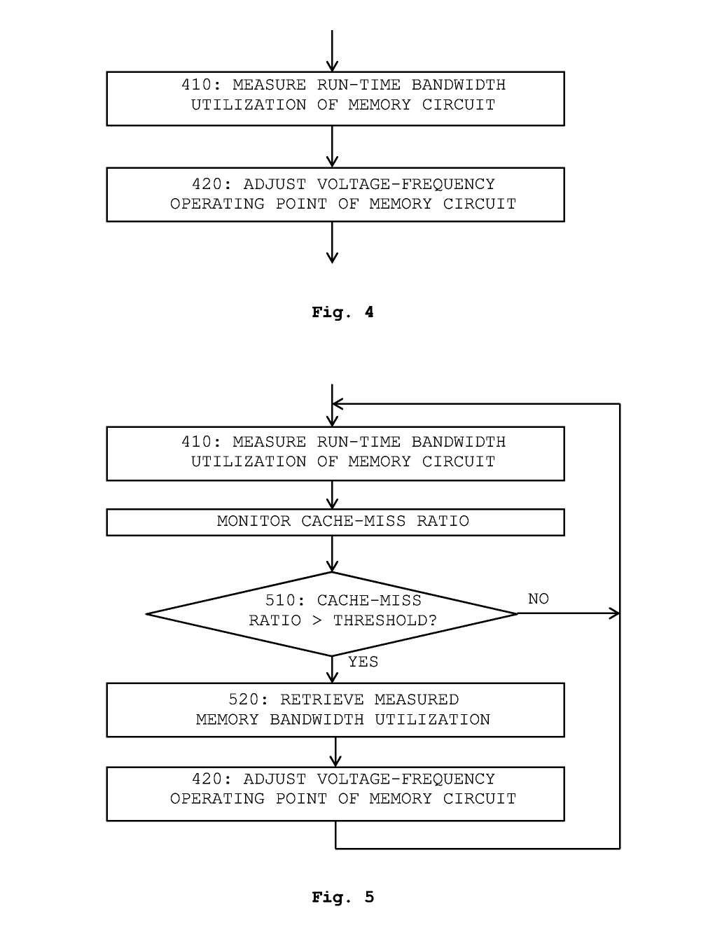

FIG. 4 is a process flow diagram illustrating a method for managing power consumption of memory in a processing system, such as might be carried out by one or more of the circuits described above. As shown at block 410, the method includes measuring run-time bandwidth utilization of a memory circuit, where the run-time bandwidth utilization reflects usage of the memory circuit by one or more processing elements. As shown at block 420, the method further includes adjusting a voltage-frequency operating point of the memory circuit, as a function of the measured run-time bandwidth utilization. These operations can be repeated, e.g., at periodic intervals, or in response to any one or more of a variety of triggers, so that the operating point of the memory circuit is dynamically adjusted in response to a processing system's requirements.

In some embodiments of the method illustrated generally in FIG. 4, the run-time bandwidth utilization reflects usage of the memory circuit by two or more processing elements, and the dynamic adjusting of the voltage-frequency operating point of the memory circuit depends on which of the two or more processing elements has or have increasing or decreasing memory bandwidth requirements. In some embodiments, the adjustments of the voltage-frequency operating point may be further based on other parameters, such as on a charging level of a battery associated with the processing system.

In some embodiments, the measuring of the run-time bandwidth utilization of the memory circuit is performed by memory-bandwidth measurement hardware that is distinct from each of the one or more processing elements, and the adjusting of the voltage-frequency operating point of the memory circuit is performed by a memory-bandwidth utilization circuit in response to utilization information provided directly to the memory-bandwidth utilization circuit by the memory-bandwidth measurement hardware or retrieved from the memory-bandwidth measurement hardware by the memory-bandwidth utilization circuit. In other embodiments, the measuring of the run-time bandwidth utilization of the memory circuit is again performed by memory-bandwidth measurement hardware that is distinct from each of the one or more processing elements, but one of the one or more processing elements receives or retrieves utilization information from the memory-bandwidth measurement hardware and controls the adjusting of the voltage-frequency operating point of the memory circuit, based on the utilization information. Other circuit configurations are possible.

In some embodiments, the adjusting of the voltage-frequency operating point is further based on performance metrics from one or more of the processing elements. FIG. 5 illustrates a variant of the method illustrated in FIG. 4, and illustrates an example of incorporating additional performance metrics into the operating point adjustment process. This example method begins, as shown at block 410, with a measurement of the run-time bandwidth utilization of a memory circuit, just as was the case in FIG. 4. In this example method, however, another performance metric is incorporated. Thus, as shown at block 505, a cache-miss ratio in a processing element (such as a CPU) is monitored. This cache-miss ratio is evaluated, as shown at block 510. If the cache-miss ratio does not exceed a predetermined threshold then the bandwidth measurement and cache-miss ratio monitoring are repeated. If, on the other hand, the cache-miss ratio does exceed the predetermined threshold, then the measured run-time bandwidth utilization is retrieved, as shown at block 520, and evaluated. As shown at block 420, the voltage-frequency operating point of the memory circuit may then be adjusted, based on the bandwidth utilization. Thus, FIG. 5 illustrates a process in which a processing element performance metric (in this case a cache-miss ratio) triggers an evaluation of the measured bandwidth utilization, which in turn results in an adjustment of the operating point of the memory.

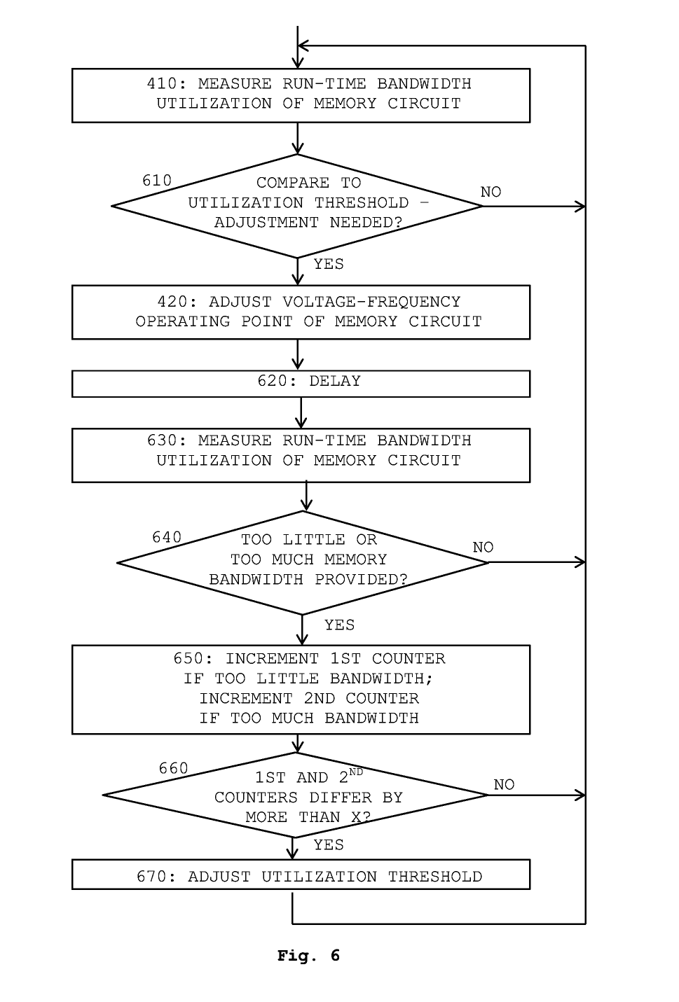

FIG. 6 illustrates an example of how the feedback loop described above may be incorporated into the process illustrated generally in FIG. 4. In the example process shown in FIG. 6, the run-time bandwidth utilization of the memory circuit is measured, as shown at block 410. The measured utilization is compared to at least one utilization threshold, as shown at block 610, to determine whether an adjustment to the operating point of the memory is needed. If no adjustment is needed, the utilization is measured again, after an appropriate time interval or after a later trigger event occurs. If an adjustment is needed, on the other hand, the voltage-frequency operating point of the memory circuit is adjusted, as shown at block 420.

After a pre-determined delay, as shown at block 620, the run-time bandwidth utilization of the memory circuit is measured again, as shown at block 630. The measured utilization is compared to the available bandwidth for the current voltage-frequency operating point to determine whether too little or too much memory bandwidth was provided by the most recent adjustment. This is shown at block 640. If too little or too much memory bandwidth was provided by the change, then one of two counters is incremented, as shown at block 650. A first counter is incremented if too little bandwidth was made available, while a second counter is instead incremented if too much bandwidth was made available. As discussed earlier, separate counters may be maintained for each of several utilization thresholds, so that the feedback loop separately controls dynamic adjustments to each threshold.

As shown at block 660, the first and second counters are compared. If they differ by more than a predetermined amount, then the utilization threshold corresponding to the counters is adjusted appropriate. For instance, if it is presumed that the threshold at issue is for triggering increases in the available memory bandwidth, then the first counter exceeding the second counter by more than the predetermined amount suggests that the current utilization threshold is tending to trigger increases in the memory bandwidth too slowly, which means that the utilization threshold should be adjusted downward, so that increases are triggered more quickly. Likewise, the second counter exceeding the first counter by more than the predetermined amount suggests that the current utilization is tending to trigger increases in the memory bandwidth too quickly, which means that the utilization threshold should be adjusted upwards. A corresponding analysis can be performed for utilization thresholds that trigger reductions in the available memory bandwidth.

The techniques detailed above may be advantageously employed in system-on-chip (SoC) devices, for example, to obtain one or more of several advantages. First, better performance will be delivered by the system (SoC/mobile device), since the DDR memory will be more accurately clocked according to bandwidth needs. Second, the system will be more power efficient, since there is less risk that the DDR memory will be routinely clocked at a higher frequency than is actually needed. In some embodiments, the feedback loop described above will allow the optimal times to increase/decrease the memory operating point to be “tuned” in, thus further improving the balance between system performance and power consumption.

In the above-description of various embodiments of the presently disclosed techniques, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When a node is referred to as being “connected”, “coupled”, “responsive”, or variants thereof to another node, it can be directly connected, coupled, or responsive to the other node or intervening nodes may be present. In contrast, when a node is referred to as being “directly connected”, “directly coupled”, “directly responsive”, or variants thereof to another node, there are no intervening nodes present. Like numbers refer to like nodes throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, nodes, steps, components or functions but does not preclude the presence or addition of one or more other features, integers, nodes, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present description, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the inventive techniques and apparatus disclosed herein. All such variations and modifications are intended to be included herein within the scope of the present disclosure.

1. A method for managing power consumption of a memory circuit in a processing system, the method comprising:
repeatedly measuring run-time bandwidth utilization of the memory circuit, wherein the run-time bandwidth utilization reflects usage of the memory circuit by one or more processing elements; and
dynamically adjusting a voltage-frequency operating point of the memory circuit, as a function of the measured run-time bandwidth utilization;
after a plurality of adjustments to the voltage-frequency operating point of the memory circuit, determining whether the adjustments to the voltage-frequency operating point have tended to provide too little memory bandwidth or to provide too much memory bandwidth, based on measurements of run-time bandwidth utilization performed after each of the plurality of adjustments to the voltage-frequency operating point of the memory circuit; and
dynamically changing one or more bandwidth utilization thresholds used to trigger adjustments to the voltage-frequency operating point, based on said determining.

2. The method of claim 1, wherein the run-time bandwidth utilization reflects usage of the memory circuit by two or more processing elements, and wherein said dynamically adjusting the voltage-frequency operating point of the memory circuit depends on which of the two or more processing elements has or have increasing or decreasing memory bandwidth requirements.

3. The method of claim 1, wherein said adjusting of the voltage-frequency operating point is further based on performance metrics from one or more of the processing elements.

4. The method of claim 3, wherein the performance metrics comprise cache-miss ratios from one or more of the processing elements.

5. The method of claim 4, further comprising:
determining that a cache-miss ratio exceeds a predetermined threshold value; and
triggering a retrieval of a measured run-time bandwidth utilization of the memory circuit, based on said determining;
wherein said adjusting the voltage-frequency operating point is performed as a function of the retrieved measured run-time bandwidth utilization.

6. The method of claim 1, wherein said adjusting of the voltage-frequency operating point is further based on a charging level of a battery associated with the processing system.

7. The method of claim 1, wherein determining whether the adjustments to the voltage-frequency operating point have tended to provide too little memory bandwidth or to provide too much memory bandwidth comprises:
incrementing a first counter value for each instance in which the measured run-time bandwidth utilization after an adjustment to the voltage-frequency operating point indicates that an available memory bandwidth is insufficient;
incrementing a second counter value for each instance in which the measured run-time bandwidth utilization after an adjustment to the voltage-frequency operating point indicates that an available memory bandwidth is more than is required; and
comparing the first and second counter values, wherein the first counter value exceeding the second counter value by at least a first predetermined threshold indicates that the adjustments to the voltage-frequency operating point have tended to provide too little memory bandwidth and wherein the second counter value exceeding the first counter value by at least a second predetermined threshold indicates that the adjustments to the voltage-frequency operating point have tended to provide too much memory bandwidth.

8. The method of claim 1, wherein said measuring of the run-time bandwidth utilization of the memory circuit is performed by memory-bandwidth measurement hardware that is distinct from each of the one or more processing elements, and wherein the adjusting of the voltage-frequency operating point of the memory circuit is performed by a memory-bandwidth utilization circuit in response to utilization information provided directly to the memory-bandwidth utilization circuit by the memory-bandwidth measurement hardware or retrieved from the memory-bandwidth measurement hardware by the memory-bandwidth utilization circuit.

9. The method of claim 1, wherein said measuring of the run-time bandwidth utilization of the memory circuit is performed by memory-bandwidth measurement hardware that is distinct from each of the one or more processing elements, wherein one of the one or more processing elements receives or retrieves utilization information from the memory-bandwidth measurement hardware and controls the adjusting of the voltage-frequency operating point of the memory circuit, based on the utilization information.

10. A processing system, comprising:
a memory circuit configured for operation at a plurality of frequency-voltage operating points;
one or more processing elements, operatively coupled to the memory circuit and configured to store data in and retrieve data from the memory circuit;
a memory-bandwidth measurement circuit operatively coupled to the memory circuit and configured to repeatedly measure run-time bandwidth utilization of the memory circuit, the run-time bandwidth utilization reflecting usage of the memory circuit by the one or more processing elements; and
a controller circuit operatively coupled to the memory-bandwidth measurement circuit and to the memory circuit and arranged to dynamically adjust the voltage-frequency operating point of the memory circuit, as a function of the measured run-time bandwidth utilization and using a feedback process that includes determining whether previous adjustments to the voltage-frequency operating point have tended to provide too little memory bandwidth or to provide too much memory bandwidth, based on measurements of run-time bandwidth utilization performed after each of a plurality of adjustments to the voltage-frequency operating point of the memory circuit, and dynamically changing one or more bandwidth utilization thresholds used to trigger adjustments to the voltage-frequency operating point, based on said determining.

11. The processing system of claim 10, wherein one of the one or more processing elements comprises the controller circuit and is configured to retrieve memory utilization information from the memory-bandwidth measurement circuit and to adjust the voltage-frequency operating point of the memory circuit via a memory controller circuit.

12. The processing system of claim 10, wherein the processing system comprises a bus analyzer circuit, wherein the bus analyzer circuit includes the controller circuit and the memory-bandwidth measurement circuit and is configured to adjust the voltage-frequency operating point of the memory circuit via a memory controller circuit.

13. The processing system of claim 10, wherein the controller circuit is configured to adjust the voltage-frequency operating point of the memory circuit in dependence on which of the one or more processing elements has or have increasing or decreasing memory bandwidth requirements.

14. The processing system of claim 10, wherein the controller circuit is configured to adjust the voltage-frequency operating point based further on performance metrics from one or more of the processing elements.

15. The processing system of claim 14, wherein the performance metrics comprise cache-miss ratios from one or more of the processing elements.

16. The processing system of claim 15, wherein the controller circuit is further configured to:
determine that a cache-miss ratio exceeds a predetermined threshold value;
trigger a retrieval of a measured run-time bandwidth utilization of the memory circuit, based on said determining; and
perform the adjusting of the voltage-frequency operating point as a function of the retrieved measured run-time bandwidth utilization.

17. The processing system of claim 10, wherein the controller circuit is configured to adjust the voltage-frequency operating point based further on a charging level of a battery associated with the processing system.

18. The processing system of claim 10, wherein the controller circuit is configured to determine whether previous adjustments to the voltage-frequency operating point have tended to provide too little memory bandwidth or to provide too much memory bandwidth by:
incrementing a first counter value for each instance in which the measured run-time bandwidth utilization after an adjustment to the voltage-frequency operating point indicates that an available memory bandwidth is insufficient;
incrementing a second counter value for each instance in which the measured run-time bandwidth utilization after an adjustment to the voltage-frequency operating point indicates that an available memory bandwidth is more than is required; and
comparing the first and second counter values, wherein the first counter value exceeding the second counter value by at least a first predetermined threshold indicates that previous adjustments to the voltage-frequency operating point have tended to provide too little memory bandwidth and wherein the second counter value exceeding the first counter value by at least a second predetermined threshold indicates that previous adjustments to the voltage-frequency operating point have tended to provide too much memory bandwidth.

19. A method for managing power consumption of a memory circuit in a processing system, the method comprising:
repeatedly measuring run-time bandwidth utilization of the memory circuit, wherein the run-time bandwidth utilization reflects usage of the memory circuit by one or more processing elements;
determining that a cache-miss ratio exceeds a predetermined threshold value; and
triggering a retrieval of a measured run-time bandwidth utilization of the memory circuit, based on said determining; and
dynamically adjusting a voltage-frequency operating point of the memory circuit, as a function of the retrieved measured run-time bandwidth utilization.

20. A method for managing power consumption of a memory circuit in a processing system, the method comprising:
repeatedly measuring run-time bandwidth utilization of the memory circuit, wherein the run-time bandwidth utilization reflects usage of the memory circuit by one or more processing elements; and
dynamically adjusting a voltage-frequency operating point of the memory circuit, as a function of the measured run-time bandwidth utilization;
wherein the run-time bandwidth utilization reflects usage of the memory circuit by two or more processing elements, and wherein said dynamically adjusting the voltage-frequency operating point of the memory circuit depends on which of the two or more processing elements has or have increasing or decreasing memory bandwidth requirements.
